(19) United States
(12) Patent Application Publication
(10) Pub. No.: US 2012/0068483 A1
(43) Pub. Date: Mar. 22, 2012

(54) Vehicle bumper having oval cross-section members

(76) Inventor: Richard Alan Fisher, Huntington Beach, CA (US)

(21) Appl. No.: 13/134,471

(22) Filed: Jun. 8, 2011

Related U.S. Application Data
(60) Provisional application No. 61/397,153, filed on Jun. 8, 2010.

(51) Int. Cl. B60R 19/44

(52) U.S. Cl. 293/142

(57) ABSTRACT

A vehicle bumper for use with police and other emergency vehicles for pushing another vehicle which is fabricated of a tubular loop defining a generally oval cross-section. The oval cross-section tubular loop is oriented such that the major axis of the oval cross-section extends front to back with respect to the host vehicle while the minor axis extends up and down. The vehicle bumper further supports a plurality of resilient pads to aid in controlling the pushed vehicle and to cushion impact transfer between the bumper and the pushed vehicle. The inventive vehicle bumper is substantially stronger and substantially lighter in weight while simultaneously providing a more attractive front view cross-section when mounted on a host vehicle. A plurality of attachments are secured to the tubular loop and are used in securing the vehicle bumper to a suitable portion of a host vehicle.

### CROSS-REFERENCE TO RELATED APPLICATIONS

This application claims the benefit of and priority under 35 U.S.C. 119(e) of U.S. Provisional Patent Application No. 61/397,153 entitled VEHICLE BUMPERS HAVING OVAL CROSS-SECTION MEMBERS filed Jun. 8, 2010 in the name of Richard Alan Fisher, the disclosure of which is incorporated herein by reference.

### FIELD OF THE INVENTION

This invention relates generally to vehicle bumpers and particularly to bumpers utilized in police, emergency or service type vehicles.

### BACKGROUND OF THE INVENTION

A number of different vehicles utilize some type of enhanced front bumper structure suitable for pushing other vehicles. Typically, emergency vehicles such as police vehicles, tow trucks and other emergency response vehicles are provided with a suitably strengthened front bumper which allows the vehicle to push another vehicle for limited distances. In most instances, the pushing activities engaged in by police and other service vehicles involves short distance pushing from behind to allow a disabled or encumbered vehicle to be pushed out of a hazardous or high use position such as a street or freeway lane to a more suitable off the road such as shoulder position.

The typical enhanced bumper utilized by police vehicles and the like comprises a pair of vertical enlarged bumper members which are joined by one or more cross bars. The vertical members and cross bar combination are supported in front of the conventional bumpers of the vehicle. In some instances, the enhanced high strength bumpers are secured to a suitable support or suitable support points provided in the vehicle structure. In other instances, the bumpers are secured to the conventional bumper attachment points within the vehicle. In either event, the object is to provide a suitably robust high-strength front bumper structure which allows the host vehicle to be able to push inoperative vehicles for short distances. While presently available enhanced front bumpers utilized by police vehicles and other emergency responders have enjoyed some success, they remain subject to several limitations.

The most common type of enhanced bumper utilized by police and other emergency vehicles includes a pair of robust vertical structural members positioned ahead of the conventional front bumper of the vehicle. The robust vertical structural members are secured to the vehicle support system. The vertical members are further supported by a plurality of cross members which may also be utilized to support one or more emergency lights or sounding apparatus.

One of the serious limitations of the conventional vertical member type enhanced bumpers described above arises in that the entire strength of the enhanced bumper system resides in the two vertical spaced apart structural members. The cross bars are frequently lighter in scale and often function primarily to support auxiliary apparatus such as lights and sounding devices. In addition, such vertical structural member type enhanced bumper systems often fail to “match up” with certain types of vehicle rear bumpers or certain “atypical” structured vehicles such as small service trucks, pickups or vans.

U.S. Pat. No. 6,905,153 issued to Murray, et al. sets forth a PUSH BUMPER having a pair of vertical structural members together with apparatus for securing the vertical members to a conventional vehicle bumper. The vertical members are joined by a generally planar cross member which defines a generally V-shaped frontal portion.

U.S. Pat. No. 6,113,164 issued to Setina sets forth an AUXILIARY PUSH BUMPER FOR MOTOR VEHICLE which is clamped to the original bumper of the host vehicle by brackets attached to bumper guards on the push bumper. The push bumper is fabricated of a plurality of bumper sections formed of extruded aluminum and having ends which are releasibly attached to the bumper guards for easy repair of the push bumper. In one embodiment, the push bumper includes a center section formed of an extruded aluminum U-shaped channel with a diagonal stiffening plated inserted into the channel. The center section is fastened at its opposed ends to a pair of bumper guards. A pair of curved side sections are fastened at their inner ends to the bumper guard plates and are further fastened at their outer ends to the frame of the host vehicle.

U.S. Pat. No. 6,318,773 issued to Storer sets forth a PUSH BAR MOUNTING SYSTEM for mounting a push bar to a vehicle bumper without significant damage to the bumper. The system includes a front and rear bracket mounted to an inner bumper of the vehicle and having top and bottom mounting tabs extending away from the inner bumper. The brackets are configured to attach to the inner bumper of the vehicle without drilling mounting holes therein. Additionally, the mounting tabs are configured to extend through a bumper fascia that surrounds the inner bumper.

U.S. Pat. No. 4,018,466 issued to Norlin sets forth a VEHICLE BUMPER ASSEMBLY having at least one profiled preferably U-shaped beam or the like adapted to be securely mounted to the frame and/or the bumper of a host vehicle. This mounting is carried forward whereby the outer contours of the bumper are located outside the vehicle body and are active in the shock absorbing capacity. The beam is provided with a plurality of stays or plates which extend transversely between the longitudinally extending limb portions of the beam and which divide the beam into pocket-like sections in which the inserts are individually mounted and arranged. The inserts preferably comprise cellular blocks and consist of a number of tubes of semi-elastic or plastic material.

While the foregoing described prior art devices have to some extent improved the art and have in some instances enjoyed commercial success, there remains nonetheless a continuing and unresolved need in the art for evermore improved robust vehicle bumper apparatus suitable for use in pushing other vehicles.

### SUMMARY OF THE INVENTION

Accordingly, it is a general object of the present invention to provide improved vehicle bumpers for use with police and other emergency type vehicles. It is a more particular object of the present invention to provide improved vehicle bumpers for use by police and other emergency type vehicles which are characterized by a robust high strength pushing member combination which is able to interact with a great variety of differently configured vehicle rear portions during pushing activity. It is a still more particular object of the present invention to provide vehicle bumpers for use by police and other emergency type vehicles which are robust and high strength while simultaneously being as light in weight as is practical.

In accordance with the present invention, there is provided a vehicle bumper comprising: a tubular loop defining a generally oval cross-section having a major axis and a minor axis; a plurality of attachment members secured to the tubular loop; a plurality of resilient pads formed to be fitted upon the tubular loop; and support means for supporting the tubular loop and for securing it to a host vehicle.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a front view of a vehicle bumper constructed in accordance with the present invention;

FIG. 2 sets forth a section view of the vehicle bumper shown in FIG. 1 taken along section lines 2-2 therein;

FIG. 3 sets forth a partial front perspective view of a typical host vehicle supporting a vehicle bumper constructed in accordance with the present invention;

FIG. 4 sets forth a partially sectioned partial front perspective view of a host vehicle supporting a vehicle bumper constructed in accordance with the present invention;

FIG. 5 sets forth a partial front perspective view of a host vehicle supporting a vehicle bumper constructed in accordance with the present invention;

FIG. 6 sets forth a section view of a vehicle bumper attachment supporting a vehicle bumper constructed in accordance with the present invention upon the front bumper of a host vehicle;

FIG. 7 sets forth a section view of a vehicle bumper constructed in accordance with the present invention taken along section lines 7-7 in FIG. 1; and

FIG. 8 sets forth a section view taken along section lines 7-7 in FIG. 1 showing an alternate embodiment attachment for the resilient pad portion of the present invention vehicle bumper.

### DESCRIPTION OF THE PREFERRED EMBODIMENTS OF THE INVENTION

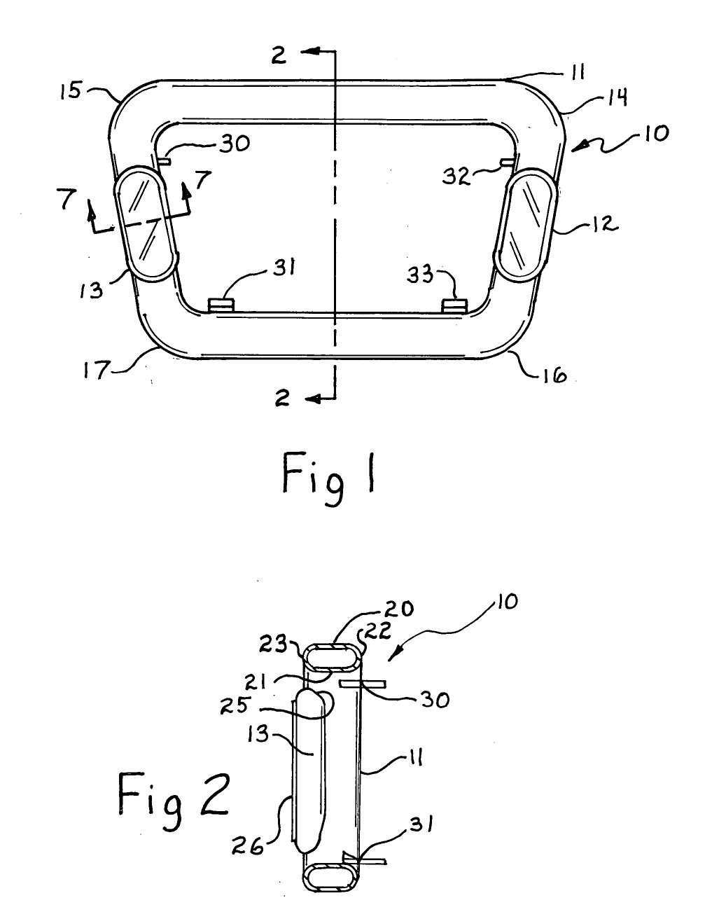

FIG. 1 sets forth a front view of a vehicle bumper constructed in accordance with the present invention and generally referenced by numeral 10. Vehicle bumper 10 is formed as a tubular loop 11 having a generally trapezoidal shape and rounded corner portions 14, 15, 16 and 17. As is better seen in FIG. 2, the cross-section shape of tubular loop 11 comprises an oval rather than the circular cross-section employed by conventional prior art structures.

Returning to FIG. 1, bumper 10 further includes a pair of resilient pads 12 and 13 secured to the front portion of the vertical members of tubular loop 11. Resilient pads 12 and 13 are preferably fabricated of a rubber material and are preferably secured to the underlying surfaces of tubular loop 11 utilizing a conventional high strength adhesive attachment. Alternatively, pads 12 and 13 may be secured utilizing a fastener attachment as shown in FIG. 8. While pads 12 and 13 are preferably fabricated of a resilient rubber material, pads 12 and 13 may if desired be fabricated of a different suitably resilient and durable material such as molded plastic or the like. The important functional aspect provided by pads 12 and 13 is the provision of padded resilient surfaces upon the front engaging edges of tubular loop 11 which avoid damage to paint or underlying surfaces of vehicles being pushed while providing sufficient friction to enhance the control exercisable by the vehicle operator during pushing operations.

It will be noted that FIG. 1 shows the present invention vehicle bumper in its simplest embodiment in which the bumper makes use of the novel oval cross-section tubular structure. The present invention enhanced and improved vehicle bumper for use on emergency and police type vehicles provides a substantially lighter weight and higher strength vehicle bumper through this use of oval cross-section tubular material rather than the conventional circular cross-section tubular material employed by prior art bumpers. This use of oval cross-section tubular material provides a substantially greater strength for any selected bumper weight or material thickness compared to the strength provided by corresponding typical circular cross-section tubular bumpers. In addition, because the major axis of the oval cross-section bumper material of the present invention is oriented forward to rearward with respect to the vehicle, the vehicle bumper is substantially “thinner” in visual appearance when viewed from the front of the host vehicle than are similar strength circular cross-section tubular bumpers. The thinner profile of the present invention bumper together with its greater strength and reduced weight substantially enhances the appeal and efficiency of the present invention bumper system. Additionally, the provision of a plurality of hard rubber pads secured upon the forward surfaces of the tubular loop provide protection for the bumper structure as well as protection of the surfaces of the vehicle being pushed.

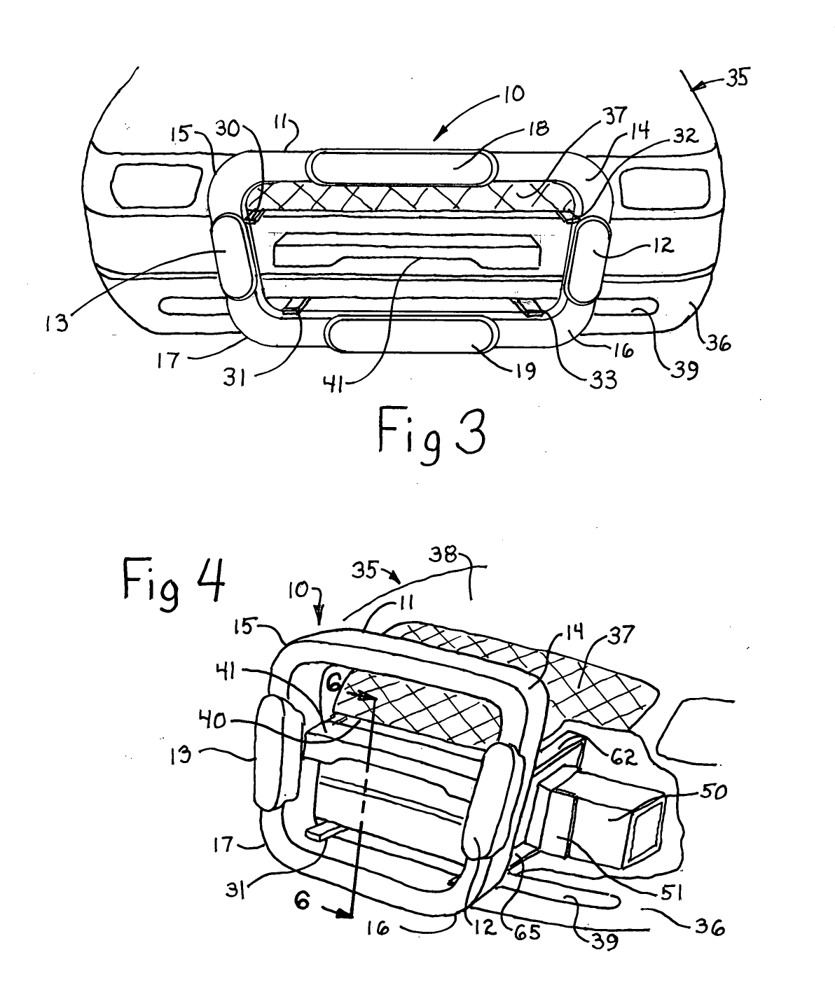

In the fabrication of the present invention, the resilient pads are sufficiently hard to be durable while nonetheless sufficiently resilient to avoid damage to paint and other vehicle surfaces during pushing operations. In addition and as is mentioned above, the rubber pad materials utilized, which may alternatively be formed of a rubber substitute such as resilient plastic or the like, also enhance the friction between the vehicle bumper and the surfaces of the vehicle being pushed. This enhanced friction in turn contributes to greater control being exercisable by the vehicle operator during pushing activities. The present invention vehicle bumper is securable to existing vehicle supports in any of the selected available bumper attachment methods of the type utilized in prior art presently available bumpers. It will be further noted by comparison of FIGS. 1 and 3 that the present invention bumper may be fabricated in an alternative manner to provide additional resilient pads on the top and bottom portions of the tubular loop and may also include a horizontal cross bar within the tubular loop to support light and sound apparatus as needed.

FIG. 2 sets forth a section view of vehicle bumper 10 taken along section lines 2-2 in FIG. 1. As described above, vehicle bumper 10 includes a tubular loop 11 formed to define an oval cross-section. As is also described above, vehicle bumper 10 further supports a pair of resilient pads such as pad 13. Vehicle bumper 10 further includes an upper attachment 30 and a lower attachment 31 secured to tubular loop 11 by conventional welding attachment. Returning to FIG. 1, it will be noted that an additional upper attachment 32 and lower attachment 33 are also supported upon tubular loop 11.

As is better seen in FIGS. 3 through 5, tubular loop 11 of vehicle bumper 10 is secured to the front portion of a host vehicle by attachment of suitably fabricated brackets to engage attachments 30 through 33 of vehicle bumper 10.

Returning to FIG. 2, it will be noted that the cross-section shape of tubular loop 11 defines an oval having flat portions 20 and 21 joined by a pair of cylindrical portions 22 and 23. This oval fabrication of tubular loop 11 greatly increases the strength of vehicle bumper 10 without increasing its weight. Stated otherwise for any given weight of tubular loop 11, substantial greater strength is provided by the oval cross-sectional shape thereof than would be provided by a corresponding weight circular cross-section vehicle bumper. As mentioned above, resilient pad 13 is preferably fabricated of a resilient rubber material or its equivalent. Resilient bumper 13 defines a cylindrical portion 25 which is secured in contact with the cylindrical portion 23 of tubular loop 11. Resilient pad 13 further defines a generally planar front surface 26 intended to engage vehicles during pushing activity. With temporary reference to FIGS. 7 and 8, it will be noted that FIG. 7 shows a cross-section view of pad 13 utilizing an adhesive attachment between pad 13 and tubular loop 11. Examination of FIG. 8 shows that an alternate form of attachment may be utilized in securing resilient pad 13 to semi-cylindrical portion 23 of tubular loop 11 utilizing a conventional fastener.

Returning to FIG. 2, it will be apparent to those skilled in the art that the remaining pads utilized on vehicle bumper 10 (resilient pad 12 seen in FIG. 1) are secured to tubular loop 11 in a similar fashion.

FIG. 3 sets forth a partial front perspective view of a typical police vehicle supporting vehicle bumper 10. As described above, vehicle bumper 10 is formed of a tubular loop 11 defining an oval cross-section as shown in FIG. 2. Tubular loop 11 defines a generally trapezoidal shaped having straight side, top and bottom portions and rounded corners 14, 15, 16 and 17. As is also described above, vehicle bumper 10 supports resilient pads 12 and 13. In FIG. 3, vehicle bumper 10 is shown supporting additional resilient pads 18 and 19 secured to the upper and lower horizontal segments of tubular loop 11. Vehicle bumper 10 further includes a pair of upper attachment brackets 30 and 32 and a pair of lower attachment brackets 31 and 33. In the manner shown in FIGS. 4, 5 and 6, attachment brackets 30 through 33 are utilized in securing bumper 10 upon the host vehicle.

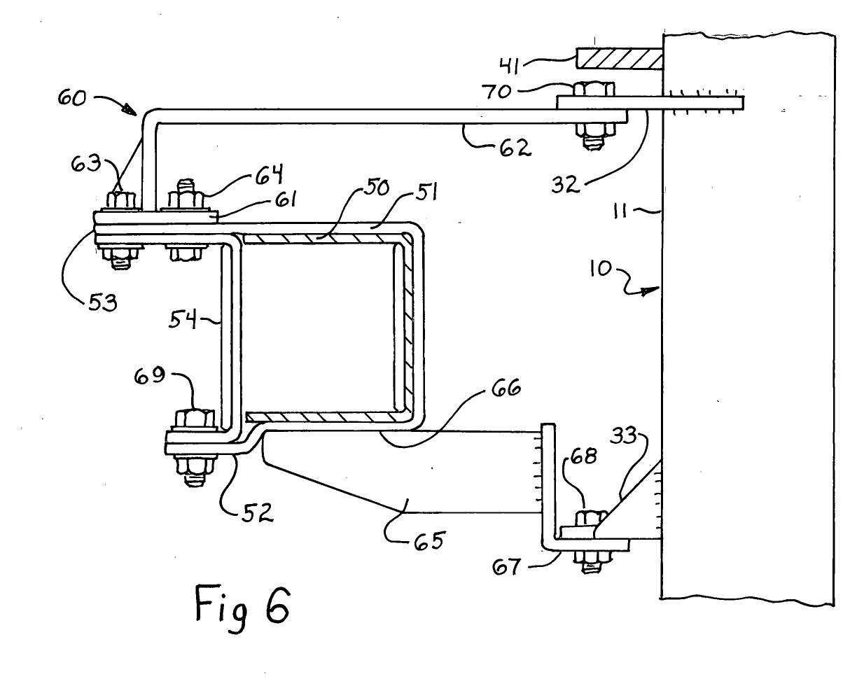

Vehicle 35 is shown to represent a typical police vehicle often described in the art as a “cruiser” in which a more or less conventional vehicle has been adapted for use as a police vehicle. While numerous modifications are typically made to vehicles utilized as cruises by police officers, for the most part the outer appearance of vehicle 35 is substantially normal. Thus, vehicle 35 supports an outer front bumper 36 defining a bumper vent 39 extending along the lower portion of bumper 36. Vehicle 35 further includes a grille 37 and a hood 38. As is better seen in FIG. 4, a convenient gap exists in the frontal portion of vehicle 35 between the lower edge of grille 37 and the upper adjacent surface of outer bumper 36. This gap is utilized to extend an appropriate support member therethrough and secure attachments 30 and 32 to be internal collision bumper of vehicle 35 in the manner shown in FIG. 6. Additionally, bumper vent 39 is utilized to provide a similar attachment between the internal crash bumper of vehicle 35 and lower attachments 31 and 33 also in the manner shown in FIG. 6. The attachment of bumper 10 upon vehicle 35 is set forth below in FIGS. 4, 5 and 6 and described in greater detail therein. However, suffice it to note here that vehicle bumper 10 supporting resilient pads 12, 13, 18 and 19 is securely mounted upon vehicle 35 forwardly from outer bumper 36. In most vehicles, outer bumper 36 is a resilient bumper fabricated of a resilient plastic material or the like. Thus in a typical application, it is anticipated that vehicle bumper 10 is supported upon vehicle 35 by attachment to the crash absorbing inner bumper (seen in FIG. 4) or, alternatively, is coupled to the supporting frame of the host vehicle (not shown). It will be noted that in the support of vehicle bumper 10 upon vehicle 35 shown in FIG. 3 that attachment is made to attachments 30 and 32 by support members extending through a gap 40 formed between grille 37 and the upper surface of outer bumper 36. In addition, it will be noted that attachment is made to lower attachments 31 and 33 by structural elements extending through bumper vent 39.

FIG. 4 sets forth a partial perspective view of vehicle 35 which is partially sectioned to show a typical attachment for vehicle bumper 10. In the example shown in FIG. 4, the attachment is made to the vehicle's crash absorbing inner bumper 50. It will be understood, however, that the present invention vehicle bumper may be secured to either crash bumper 50 or a suitable portion of the vehicle supporting frame (not shown) without departing from the spirit and scope of the present invention. It has been found that attachment to crash absorbing bumper 50 provides advantage in that vehicle bumper 10 then is afforded the energy absorbing characteristic provided by interior bumper 50 should a severe impact to bumper 10 be received. It will also be noted by comparison of FIGS. 3 and 4 that vehicle bumper 10 is shown in FIG. 4 without resilient pads 18 and 19. This is a matter of choice in the utilization of vehicle bumper 10. It will be noted in FIGS. 3 and 4 that a cross member 41 extends horizontally within the interior of tubular loop 11. Cross member 41 is secured to the interior of tubular loop 11 using conventional fabrication such as welding attachment or using suitable brackets (not shown). Cross member 41 provides a convenient area within vehicle bumper 10 for mounting apparatus such as lights or sound producing equipment such as a “haler” or the like. Additionally, a sound producing apparatus such as a siren may, if desired, be supported upon cross member 41.

More specifically and as is described above, vehicle 35 includes an outer bumper 36, a grille 37 and a hood 38. As is also described above, a gap 40 is formed between the lower edge of grille 37 and the upper surface of outer bumper 36. FIG. 4 also shows an internal crash absorbing bumper 50 supported within the interior of vehicle 35 in accordance with conventional fabrication techniques. Thus, while not shown in FIG. 4, it will be understood that crash absorbing bumper 50 is positioned behind outer bumper 36 and is coupled to the supporting frame of vehicle 35 (not shown) through an energy absorbing structure. Such internal crash absorbing bumpers are well known in the art and have been utilized in vehicles for many years. Suffice it to note here that crash absorbing bumper 50 is supported with sufficient strength to provide a convenient attachment point for attaching the support apparatus utilized to further support vehicle bumper 10. The structure utilized in coupling vehicle bumper 10 to crash absorbing internal bumper 50 is set forth below in FIG. 6 in greater detail. However, suffice it to note here that this apparatus includes a U-shaped bracket 51 which is fitted upon crash absorbing bumper 50 and which is secured by a back plate 54 (seen in FIG. 6). In addition, U-shaped bracket 51 further supports an upper arm 62 which passes forwardly through gap 40 and beyond and which is secured to attachment 32 of bumper 10 (seen in FIG. 3). Finally, U-shaped bracket 51 further supports a lower arm 65 which extends forwardly through bumper 39 and is secured to attachment 33 of vehicle bumper 10. It will be understood that a corresponding structure is secured on the remaining side of vehicle bumper 10 securing attachments 30 and 31 to crash absorbing bumper 50.

As is described above, vehicle bumper 50 includes a generally trapezoidally shaped tubular loop 11 having corner portions 14, 15, 16 and 17 and further supporting a pair of resilient pads 12 and 13. In accordance with the present invention, tubular loop 11 is formed to define a generally oval cross-section seen for example in FIG. 2. It will also be noted that in FIG. 4 vehicle bumper 10 does not utilize resilient pads 18 and 19. It will be understood, however, that resilient pads 18 and 19 may, if desired, be secured to vehicle bumper 10 in the manner shown in FIG. 3. A cross member 41 is supported by the interior of tubular loop 11 and occupies a generally horizontal position which, as described above, may be utilized for supporting additional apparatus such as lights and sound apparatus.

In the embodiment of the present invention shown in FIG. 4, the attachment of vehicle bumper 10 to internal crash absorbing bumper 50 is carried forward substantially in accordance with conventional fabrication techniques. As mentioned above, the attachment of vehicle bumper 10 supports to internal crash bumper 50 is opportune in that it provides an energy absorbing support for vehicle bumper 10.

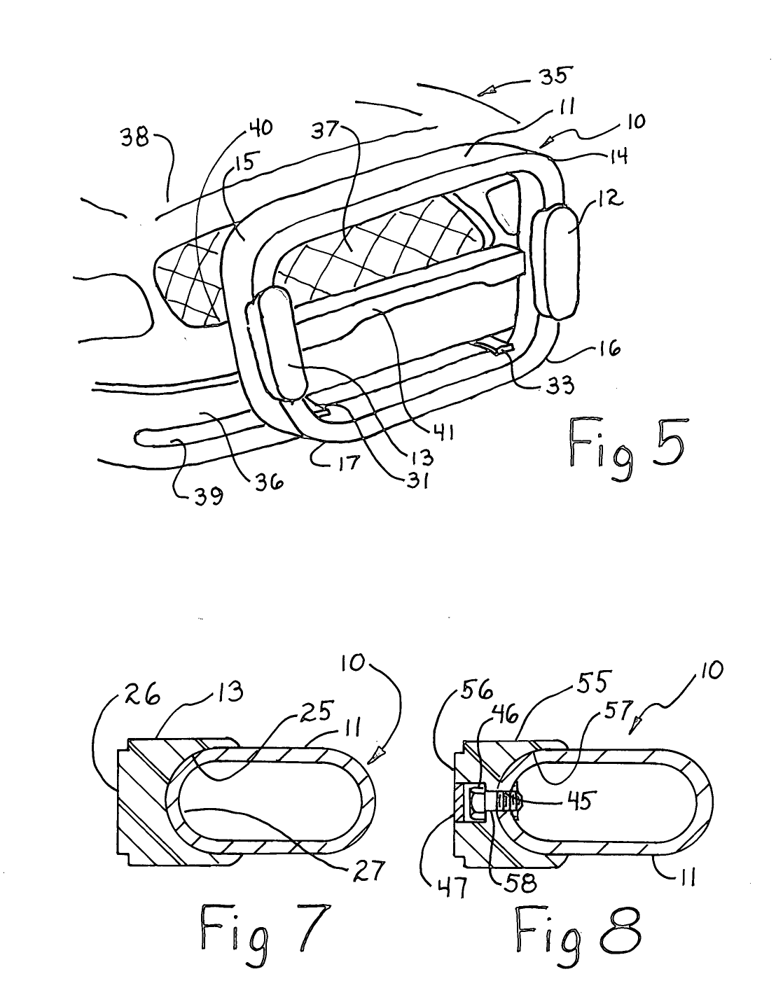

FIG. 5 sets forth a partial perspective view of vehicle 35 supporting vehicle bumper 10. As described above, vehicle 35 includes an outer bumper 36 defining a bumper vent 39. As is also described above, vehicle 35 includes a hood 38 and a grille 37. A gap 40 is formed between the lower edge of grille 37 and the upper surface of outer bumper 36. Vehicle bumper 10 is formed of a generally trapezoidal tubular loop 11 defining straight portions joined by curved corner portions 14, 15, 16 and 17. Vehicle bumper 10 further supports resilient pads 12 and 13. In the manner described above, vehicle bumper 10 is secured to a selected internal portion of vehicle 35.

FIG. 6 sets forth a partial section view of a typical attachment of vehicle bumper 10 to an internal crash absorbing bumper 50 supported within vehicle 35 in accordance with conventional fabrication techniques. A generally U-shaped bracket 51 is fitted upon crash absorbing bumper 50 and includes a rearwardly extending upper end 53 and a rearwardly extending lower end 52. A generally planar doubly flanged back plate 54 is fitted against the rear portion of crash absorbing bumper 50 and is positioned against the underside of upper end 53 and the upper side of lower end 52. A conventional nut and bolt fastener 69 secures the lower end of back plate 54 to lower end 52 of U-shaped bracket 51. A lower arm 65 is joined to the bottom surface of U-shaped bracket 51 at a weld joint 66. Lower arm 65 extends forwardly to support an arm bracket 67. An upper attachment bracket 60 includes a flange 61 received upon the upper surface of upper end 53. A pair of conventional nut and bolt fasteners 63 and 64 secure back plate 54 and flange 61 to upper end 53 of U-shaped bracket 51. Upper attachment bracket 60 extends forwardly forming an upper arm 62.

As described above, vehicle bumper 10 includes a tubular loop 11 formed to define an oval cross-section and having an upper attachment 32 and a lower attachment 33. Upper attachment 32 is secured to upper arm 62 by a conventional nut and bolt fastener 70 while lower attachment 33 is joined to arm bracket 67 by a conventional nut and bolt fastener 68. Vehicle bumper 10 also includes a cross member 41.

It will be apparent to those skilled in the art that the structure shown in FIG. 6 which provides supports for attachments 32 and 33 of tubular loop 11 is repeated on the opposite side of vehicle 35 and provides corresponding support for attachments 30 and 31 (seen in FIG. 3). Examination of FIG. 6 shows that tubular loop 11 is oriented such that the major axis of its oval cross-section extends front to rear while the minor axis thereof extends top to bottom. This orientation provides the slimmest appearance when observed from the vehicle front and provides the strongest force resisting structure to forces imparted to the frontal edge of tubular loop 11. In this manner, vehicle bumper 10 may be fabricated as light as possible and as strong as possible while maintaining a more attractive frontal appearance.

FIG. 7 sets forth a section view of vehicle bumper 10 taken along section lines 7-7 in FIG. 1. As described above, vehicle bumper 10 includes a tubular loop 11 defining an oval cross-section. As is also described above, resilient pad 13 defines a planar surface 26 and a generally cylindrical interior surface 25. In the embodiment shown in FIG. 7, resilient pad 13 is received upon the forward portion of tubular loop 11 and is secured thereto by an adhesive material 27.

FIG. 8 sets forth a section view of vehicle bumper 10 utilizing an alternate embodiment for securing a resilient pad to tubular loop 11. The embodiment shown in FIG. 8 is substantially identical to the embodiment shown in FIG. 7 in that tubular loop 11 defines an oval cross-section having a generally cylindrical frontal edge. A resilient pad 55 fabricated in general similarity to resilient pad 13 defines an internal cylindrical surface 57 for receiving the forward portion of tubular loop 11. The embodiment shown in FIG. 8 differs from the embodiment of FIG. 7, however, in that it accommodates a conventional nut and bolt fastener for securing resilient pad 55 upon tubular loop 11. Accordingly, to accommodate this different form of attachment, tubular loop 11 defines an aperture 45 in the frontal portion thereof. Correspondingly, resilient pad 55 defines an aperture 58 extending inwardly from planar face 56. A conventional nut and bolt fastener 46 extends through aperture 58 and aperture 45 and is secured in place by a conventional cooperating threaded nut. To maintain the resilient character of frontal surface 56 of resilient pad 55 and to avoid damage to a vehicle being pushed which might otherwise be caused by fastener 46, a recessed plug 47 formed of a resilient rubber or plastic material is secured to resilient pad 55 by snap-fit or adhesive attachment.

What has been shown is a vehicle bumper for use with police and other emergency vehicles for pushing another vehicle which is fabricated of a tubular loop defining a generally oval cross-section. The oval cross-section tubular loop is oriented such that the major axis of the oval cross-section extends front to back with respect to the host vehicle while the minor axis extends up and down. The vehicle bumper further supports a plurality of resilient pads to aid in controlling the pushed vehicle and to cushion impact transfer between the bumper and the pushed vehicle. The inventive vehicle bumper is substantially stronger and substantially lighter in weight while simultaneously providing a more attractive front view cross-section when mounted on a host vehicle. A plurality of attachments are secured to the tubular loop and are used in securing the vehicle bumper to a suitable portion of a host vehicle.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A vehicle bumper comprising:
a tubular loop defining a generally oval cross-section having a major axis and a minor axis;
a plurality of attachment members secured to said tubular loop;
a plurality of resilient pads formed to be fitted upon said tubular loop; and
support means for supporting said tubular loop and for securing it to a host vehicle.

2. The vehicle bumper set forth in claim 1 wherein said tubular loop is formed to orient said major axis forwardly to rearwardly and to orient said minor axis upwardly to downwardly.

3. The vehicle bumper set forth in claim 2 wherein said generally oval cross-section includes generally semi-cylindrical forward and rearward portions and generally planar upper and lower portions.

4. The vehicle bumper set forth in claim 3 further including a cross member extending horizontally across said tubular loop and having a surface for supporting a plurality of lights.

5. The vehicle bumper set forth in claim 3 wherein said tubular loop defines a generally trapezoidal loop having parallel top and bottom straight portions, angled straight side portions and rounded corners extending between said top and bottom portions and said side portions.

6. The vehicle bumper set forth in claim 5 wherein said resilient pads are secured to said generally semi-cylindrical forward portions of said side portions of said tubular loop.

7. The vehicle bumper set forth in claim 6 wherein said resilient pads are secured to said generally semi-cylindrical forward portions of said top and bottom portions of said tubular loop.

8. The vehicle bumper set forth in claim 6 wherein said angled straight side portions of said tubular loop are angled inwardly and downwardly.
